(19) United States
(12) Patent Application Publication
(10) Pub. No.: US 2005/0234786 A1
(43) Pub. Date: Oct. 20, 2005

(54) General ledger maintenance in an inventory accounting system

(75) Inventor: Manoj K. Aggarwal, Seattle, WA (US)

Correspondence Address: MICROSOFT CORPORATION C/O WESTMAN;CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Microsoft Corporation, Redmond, WA (US)

(21) Appl. No.: 10/815,093

(22) Filed: Mar. 31, 2004

(51) Int. Cl. G06F 17/60

(52) U.S. Cl. 705/30

(57) ABSTRACT

In a method of maintaining a general ledger and a computerized inventory accounting system utilizing a perpetual average inventory valuation, an inventory sales transaction is posted to the general ledger having a first amount that corresponds to a first rate for items in inventory. Next, an inventory purchase transaction is posted to the general ledger after the posting of the inventory sales transaction that result in a change in the first rate of the inventory sales transaction. Finally, an adjustment value corresponding to a change in the first amount due to the change in the first rate is calculated and a corrected transaction having the adjustment value is posted to the general ledger.

### FIELD OF THE INVENTION

The present invention generally relates to computerized inventory accounting systems and, more particularly, to methods of maintaining a general ledger that are in accordance with preferred accounting rules.

### BACKGROUND OF THE INVENTION

Computerized accounting systems and programs (i.e., software applications) are configured for use by both accountants and non-accountants. These systems allow users to set up various types of accounts such as general ledger, inventory, order entry, accounts receivable, accounts payable, bank manager, and payroll accounts. Each account, or account module, of the accounting system are typically fully integrated and share common data. As a result, a transaction can be entered, for example, as an invoice, and the accounting system automatically performs the necessary credits and debits on the affected accounts including posting the transaction to the general ledger without requiring the user to reenter any data. Thus, such computerized accounting systems are ideal tools for the non-accountant user. Additionally, they save time, reduce the likelihood of errors, and eliminate the need to reenter data for posting to the general ledger.

The general ledger maintains a list of posted transactions relating to all of the accounts of the system. As is well known for double entry bookkeeping systems, valid accounting transactions consist of a debit component and a credit component where the absolute value of the debit component is equal to the absolute value of the credit component. The general ledger module typically maintains the summary information of the transaction histories and balances for all of the accounts of the system, while the individual account modules maintain more detailed historical transaction data and balances for their respective accounts. For example, a user can generate an invoice for an inventory transaction in which ten items are sold to a customer. The invoice may list various information about the sale, such as customer information, the date of sale, the quantity of items sold, the cost for each item, and the total cost of the sale. When the user saves the invoice, the transactions recorded therein are posted to the general ledger of the system by recording only the debit and credit components (dollar amounts) and the transaction date.

Inventory is typically accounted for on a perpetual basis where the cost of each item in inventory is recorded as a debit to the inventory account when purchased. When an item is sold, its cost is credited to the inventory account and debited from a Cost Of Goods Sold (COGS) account. Accordingly, it is necessary to determine a value for sold items in order to record the proper amount for the transaction in the COGS account. The first time an item is purchased, the value is whatever was paid for it. However, as additional stock is obtained at a different price, the valuation of the items can vary.

There are three typical valuation methods that are used in perpetual inventory accounting systems. These methods include First-In, First-Out (FIFO), Last-In, Last-Out (LIFO), and average cost methods. The FIFO method assumes that the first item to come into the inventory are the first items sold, so the most recent unit cost is used to determine the inventory's value. The LIFO method assumes that the last item to come into the inventory are first items sold, so that the oldest unit cost is used to determine he inventory's value. The average cost method uses the average unit cost for all items that were available for sale during the accounting period. The average cost is the total cost of all goods divided by the number in stock.

Problems can arise in accounting systems using a perpetual average inventory valuation method with regard to providing real time accurate inventory valuation and strict maintenance of the general ledger. In general, problems arise as a result of valuation changes to the inventory that necessitate changes to inventory sales transactions that have already been posted to the general ledger. These valuation changes can be caused by sales of items that are not in stock and are later purchased to fill the sale, but at a different price than that at which they were sold. Additionally, valuation changes can arise due to the posting of a purchase transaction to the general ledger that is dated prior to a posted sales transaction and would change the valuation of the items sold in posted sales transaction.

An example of this can be illustrated by a general ledger that includes a posting of an inventory sales transaction that includes a recording of $50.00 corresponding to sale of 5 items at a value of $10.00 each on April 16^{th}. Subsequently, a purchase invoice is discovered that is dated April 12^{th} and would have changed the valuation of items sold on April 16^{th} to $9.00 each when posted to the general ledger. As a result, the posted inventory sales transaction of April 16^{th} is incorrect and should have been recorded as a $45.00 entry.

Some computerized accounting systems of the prior art handle such valuation problems by refreshing the general ledger to reflect only the correct postings. In other words, they modify the existing transaction postings to reflect the correct amounts. Thus, for the example provided above, the general ledger would be refreshed by posting the inventory purchase transaction and changing the posted inventory sales transaction of April 16^{th} to $45.00. Unfortunately, such general ledger refreshing practices fail to meet an accounting rule that is preferred by auditors and accountants, which prohibits the editing or deleting of transactions that have been posted to the general ledger.

Therefore, a need exists for a method of handling inventory transactions that are to be posted to the general ledger that would affect the valuation of posted inventory transactions while maintaining the sanctity of the general ledger to thereby satisfy the accounting rule preferred by auditors and accountants.

### SUMMARY OF THE INVENTION

The present invention is generally directed to a method of maintaining a general ledger in a computerized inventory accounting system utilizing a perpetual average inventory valuation. In the method, an inventory sales transaction is posted to the general ledger having a first amount that corresponds to a first rate for items in inventory. Next, an inventory purchase transaction is posted to the general ledger after the posting of the inventory sales transaction, which results in a change in the first rate of the inventory sales transaction. An adjustment value is then calculated that corresponds to a change in the first amount due to the change in the first rate. Finally, a corrective transaction is posted to the general ledger having the adjustment value.

In accordance with another embodiment of the invention, an inventory sales transaction is posted to the general ledger that includes a sale of a first quantity of items (sold items) of an inventory at a first rate and on a first transaction date. Next, an inventory purchase transaction is posted to the general ledger after the posting of the inventory sales transaction, which includes a purchase of a second quantity of the items at a second rate on a second transaction date that is on or before the first transaction date. An adjustment value is then calculated that corresponds to a change in a value of the posted inventory sales transaction due to a valuation change for the sold items as a result of the posted inventory purchase transaction. Finally, a corrective transaction is posted to the general ledger having the adjustment value.

Another aspect of the present invention is directed to a method of editing an original inventory transaction that has been posted to the general ledger. The original inventory transaction posting is for a first amount corresponding to a sale or purchase of a first quantity of items at a first rate. In the method, a nullifying inventory transaction having the original amount is posted to the general ledger such that it nullifies the original inventory transaction posting. Next, a new inventory transaction is posted to the general ledger, which corresponds to a modified version of the original inventory transaction.

### BRIEF DESCRIPTION OF THE DRAWINGS

FIG. 1 is a block diagram illustrating an environment in which the present invention may be used.

FIG. 2 is a block diagram illustrating a software environment in which the present invention can be used.

FIG. 3 is a flowchart illustrating a method of maintaining a general ledger in a computerized inventory accounting system utilizing a perpetual average inventory valuation, in accordance with embodiments of the invention.

FIGS. 4-6 are block diagrams of exemplary general ledgers, each of which include entries that have been posted in accordance with embodiments of the method illustrated in the flowchart of FIG. 3.

FIG. 7 is a flowchart illustrating a method of editing an original transaction that has been posted to a general ledger, in accordance with an embodiment of the invention.

FIG. 8 is a block diagram of an exemplary general ledger to which entries have been posted in accordance with the method illustrated in the flowchart of FIG. 7.

### DETAILED DESCRIPTION OF ILLUSTRATIVE EMBODIMENTS

The present invention generally relates to a computerized accounting system that includes inventory-related accounts, which utilize a perpetual average valuation method, and is designed to simplify the recording of inventory transactions while maintaining the sanctity of the general ledger. Prior to describing the present invention in greater detail, an exemplary computing environment in which the present invention can exist will be described.

### Computing Environment Overview

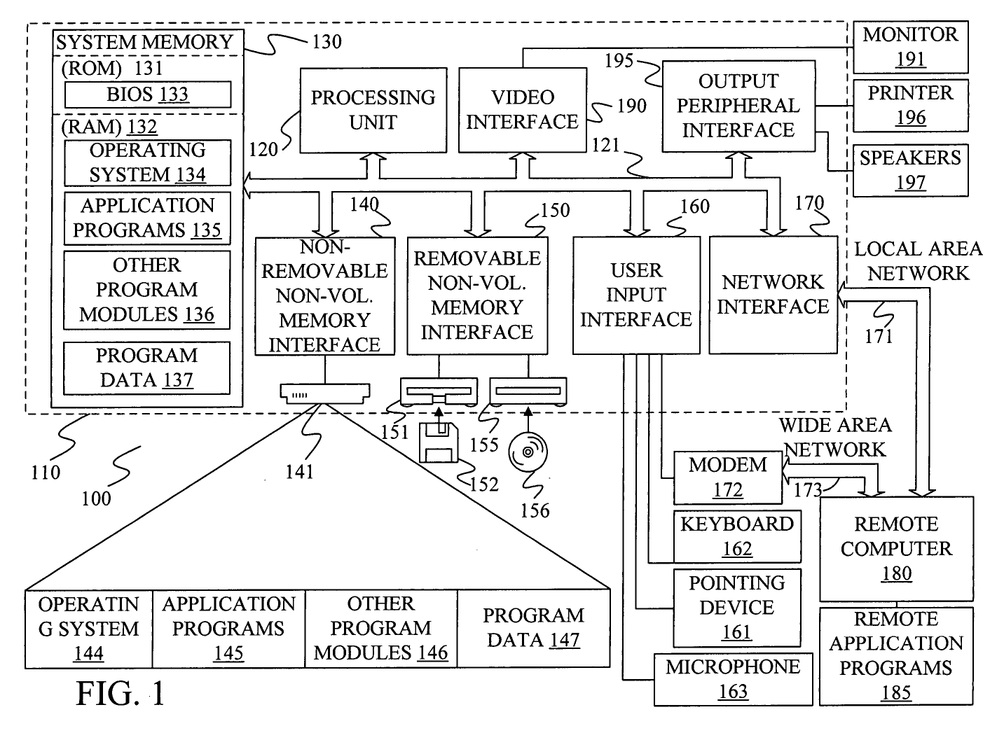

FIG. 1 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

As noted above, the present invention can be carried out on a computer system such as that described with respect to FIG. 1. Alternatively, the present invention can be carried out on a server, a computer devoted to message handling, or on a distributed system in which different portions of the present invention are carried out on different parts of the distributed computing system.

### High Level Software Environment Overview

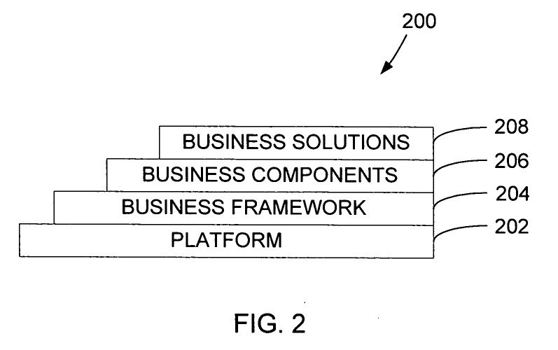

FIG. 2 is a block diagram of a high level environment 200 in which the present invention may reside. Environment 200 shows a tools and server platform 202, a business framework 204, business components 206, in which the present invention resides, and a business solution 208. Tools and server platform 202 illustratively provide a platform for services which allow applications to communicate and share data over a wide area network. The platform 202 can, for example, include tools and server systems to enable this functionality. Business components 206 illustratively include the functionality for business applications which are packaged together based on a developer's interaction with business framework 204. Business components 206 can, for example, include a computerized accounting system or application in accordance with embodiments of the present invention that includes executable instructions for carrying out the methods described herein as well as the formation and maintenance of a general ledger, transactional documents and, other financial application modules. Additionally, business components 206 can include sales force automation services and customer relation management applications. By writing business components 206 using framework 204, these components are extensible and can be utilized to serve the needs of multiple users, depending on the level of functionality and complexity that is desired.

Each business solution 208 includes one or more applications. The applications are groups of business components presented through a user interface and individually deployed.

Business framework 204 is used by developers of business components 206. Business framework 204 enables business applications in a productive, reliable and consistent fashion.

### Overview of Computerized Accounting Systems or Applications

Computerized accounting systems or applications are generally configured to perform basic accounting tasks for both the accountant and the non-accountant user, including the maintenance of various accounts, including inventory-related accounts, and a general ledger. The general ledger maintains a list of posted transactions relating to an account that are recorded in transaction documents, such as an invoice, a purchase receipt, a vendor bill, a check, a deposit, a journal entry, or other transaction documents that record or represent financial transactions for the business. Typically upon saving of the transaction document, the computerized accounting system or application posts the transactions contained in the transaction document to the general ledger. The posting of the transactions is generally implemented by posting logic in accordance with rules that are contained in a table or in accordance with a model. Accordingly, the general ledger records the history of the financial transactions of an account.

There are many strict accounting rules that are preferred by auditors and accountants that enable them to perform their jobs more efficiently while reducing the likelihood of errors. One such rule prohibits editing or deleting transactions posted to the general ledger. Accordingly, the sanctity of the general ledger must be maintained by only allowing postings of transactions to the general ledger.

### Prior Art Computerized Accounting Systems or Applications

Computerized accounting systems or applications of the prior art are configured to be very user friendly and are geared toward users having little understanding of accounting. Unfortunately, prior art computerized accounting systems fail to adhere to the strict rules preferred by auditors and accountants.

In general, prior art methods of maintaining inventory-related accounts that utilize perpetual average valuation, fail to maintain the sanctity of the general ledger. More particularly, such methods allow for the modification to the transactions posted to the general ledger to accommodate for valuation changes to the inventory that affect transactions that have already been posted to the general ledger.

### Computerized Inventory Accounting System of the Present Invention

The present invention is directed to methods of maintaining the sanctity of general ledger in accordance with preferred accounting rules by accommodating inventory transactions that affect inventory transaction amounts that have already been posted in the general ledger without refreshing the general ledger. References made herein to sales transactions are intended to describe incoming transactions relating to, for example, sales invoices, vendor return/credit memos, and other incoming transactions. References made herein to purchase transactions are intended to describe outgoing transactions relating to, for example, purchase receipts, credits, returns, and other outgoing transactions.

In general, the present invention posts corrective transactions to the general ledger which compensate for item valuation changes that occur, or become known, subsequent to the posting of purchase transactions, and affect the amount posted for the purchase transactions. There are generally two situations that can cause such valuation changes. For instance, the above-describe valuation change can occur from the posting of an inventory purchase transaction that includes a purchase of items that will be used to fulfill a preceding inventory sales transaction and where the valuation or rate for the items of the sales transaction changes as a result of the inventory purchase transaction. Additionally, such valuation changes can stem from the posting of an inventory purchase transaction is posted having a transaction date that precedes the transaction date of a posted inventory sales transaction and results in a change to the valuation or rate for the items sold in the inventory sales transaction.

It should be understood that the method of the present invention can be used to maintain general ledgers in accordance with conventional single and double entry bookkeeping practices. Single entry bookkeeping generally posts each transaction in a single account ledger, while double entry bookkeeping posts each transaction in two account ledgers (e.g., a debit account and a credit account). To simplify the discussion of the invention, most of the examples provided herein will be in accordance with a double entry bookkeeping practice.

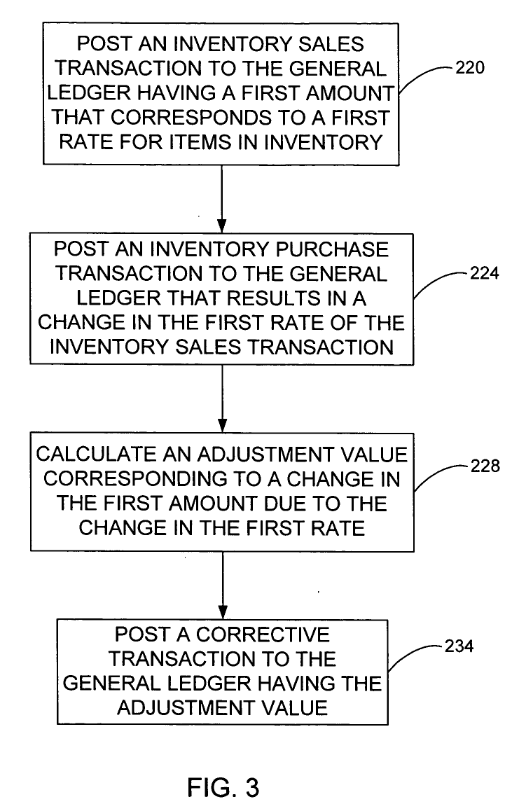

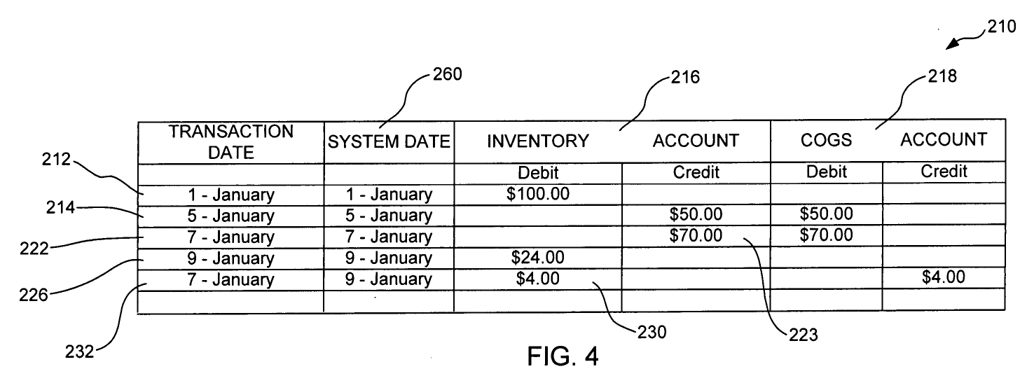

FIG. 3 is a flowchart of a method of maintaining a general ledger in a computerized inventory accounting system utilizing a perpetual average inventory valuation. The method can be implemented in a suitable computing system, such as the system 100 (FIG. 1) described above, through the execution of program instructions that correspond to the steps of the method. Embodiments of the method of the present invention will be described with reference to an exemplary general ledger 210, such as is shown in the block diagram of FIG. 4. The general ledger 210 initially includes inventory transactions including an inventory purchase transaction 212 and an inventory sales transaction 214. The inventory purchase transaction 212 includes a purchase of ten items for inventory at a cost of $100.00 on a transaction date (i.e., date of the actual transaction) of January 1^{st}, which is posted in the general ledger 210 as a debit to the inventory account 216. Assuming that the purchase constitutes the entire inventory, the rate for each item in inventory in accordance with the perpetual average valuation method is $10.00. The inventory sales transaction 214, having a transaction date of January 5^{th}, includes a sale of five items. The amount posted in the general ledger 210 is $50.00 in the credit column of the inventory account 216, which corresponds to the cost of the goods sold based upon the valuation for the items at the time of the transaction. In accordance with double entry bookkeeping methods, a corresponding debit is recorded in the Cost of Goods Sold (COGS) account 218 of the general ledger 210. As a result of the inventory transactions 212 and 214, there remain two items in inventory that are valued at a rate of $10.00 each.

The method of the present invention begins at step 220, in which an inventory sales transaction is posted to the general ledger 210 having a first amount that corresponds to a first rate for items in inventory. This is illustrated in the general ledger of FIG. 4 by inventory sales transaction 222, which has a transaction date of January 7^{th}, and includes a sale of seven of the items. Due to the present valuation or rate for each of the items at $10.00 (first rate), the amount recorded in the credit column of the inventory account 216 and the debit column of the COGS account 218 is $70.00 (first amount 223), even though only five of the seven items are currently available in inventory. As a result, the inventory sales transaction 222 includes a sale of two out-of-stock items.

At step 224 of the method, an inventory purchase transaction, such as inventory purchase transaction 226, is posted to the general ledger 210 that results in a change in the first rate of the inventory sales transaction 222 and, thus, a change in the first amount 222 that was calculated based upon the first rate. Various forms of the inventory purchase transaction 226 will be discussed in greater detail below.

The present invention avoids refreshing or modifying the inventory purchase transaction 222 posted to the general ledger 210, which would violate the sanctity of the general ledger 210. Instead, at step 228 of the method, an adjustment value 230 is calculated corresponding to a change in the first amount 223 of the inventory purchase transaction 222 due to the change in the first rate, which is then posted to the general ledger 210 as a corrective transaction 232, at step 234 of the method. Accordingly, the adjustment value 230 corresponds to a difference between the amount that should have been posted to the general ledger 210 for the inventory transaction posting 222 and the first amount 230 that was actually posted to the general ledger 210.

The inventory purchase transaction of step 224 of the method that results in a change to the first rate of the inventory sales transaction 222, can take on several different forms. In general, the inventory purchase transaction can be either (a) an inventory purchase transaction that is subsequent to, and operates to fulfill, a posted inventory sales transaction; (b) an inventory purchase transaction for a quantity of p items that predates a posted inventory sales transaction for a quantity of x items, of which a quantity of y items were out of stock, and where p is greater than y; or (c) an inventory purchase transaction for a quantity of p items that predates a posted inventory sales transaction for a quantity of x items, of which a quantity of y items were out of stock, and where p is less than y. Each of the above situations will be discussed in order below along with the corresponding adjustment value calculations.

### Subsequent Inventory Purchase Transaction Fulfills an Inventory Sales Transaction—Situation (a)

An example of situation (a) is provided in FIG. 4, which shows a purchase transaction 226 having a transaction date of January 9^{th} that includes a purchase of three items at a second rate of $8.00 each. Two of the three purchased items are used to fulfill the preceding inventory purchase transaction 222, discussed above. The inventory account is debited by $24.00. However, there is a perpetual average valuation change to the inventory items that were sold in the inventory sales transaction 222 caused by a difference between the first and second rates. Accordingly, the posted first amount 223 of $70.00, which was based on a calculation using the first rate of $10.00, is incorrect.

In accordance with one embodiment of the present invention, the adjustment value 230 is essentially the difference between what the first amount 223 should have been when the subsequent purchase transaction 226 is taken into account and the first amount 223. In accordance with the example given above, the first amount 223 should have been the sum of the remaining five items in inventory at the first rate of $10.00 each ($50.00) and two of the newly purchased items at the second rate of $8.00 each ($16.00), which totals $66.00. Accordingly, the adjustment value 230 is $4.00 ($66.00-$70.00). In accordance with step 234 of the method, the adjustment value 230 is posted to the general ledger 210 as a corrective transaction 232 to the general ledger. When the adjustment value 230 is negative, as in the present example, the corrective transaction 232 is posted by debiting the inventory account 216 and crediting the COGS account 218 by the adjustment value, as shown in FIG. 4. When the adjustment value 230 is positive, the corrective transaction 232 is posted by crediting the inventory account 216 and debiting the COGS account 218.

### Predated Inventory Purchase

### Transaction—Situation (b)

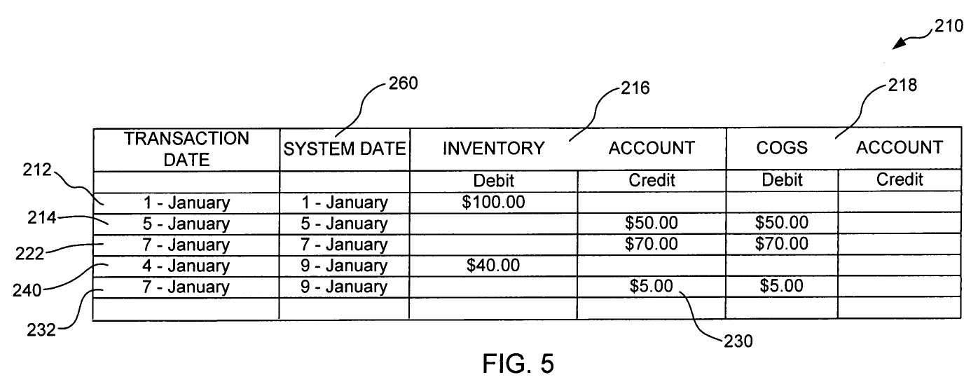

An example of situation (b) will be discussed with reference to the exemplary general ledger 210 of FIG. 5. Initially, the general ledger 210 includes the purchase and sales transactions 212 and 214 dated January 1^{st} and January 5^{th}, respectively, as described above. The general ledger 210 also includes a posting of the inventory sales transaction 222 on January 7^{th} (first transaction date) at a first rate (w) of $10.00 each for a quantity of seven (first quantity x) items, of which two (out-of-stock quantity y) items were out of stock. Following the posting of the inventory sales transaction 222, an item receipt for a purchase of five (second quantity p) items at a second rate (r) of $8.00 each is discovered having a second transaction date of January 4^{th}, which predates the first transaction date of transaction 222. The discovered inventory purchase transaction is posted to the general ledger 210 on January 9^{th} as inventory purchase transaction 240. As a result, the second quantity of purchased items p (5) is greater than the out-of-stock quantity y (2). In accordance with this embodiment of the invention, the adjustment value 230 is calculated in accordance with Equation 1 resulting in an adjustment value of positive $5.00.

$$\begin{matrix}Adjustment Value = ( y * r ) + ( ( x - y ) * w ) - ( x * w ) \\ = ( 5 * 8 ) + ( ( 7 - 2 ) * 10 ) - ( 7 * 10 ) \\ = \$5 .00\end{matrix} \qquad Eq . 1$$

As stated above, when the adjustment value 230 is negative, the corrective transaction 232 is posted by debiting the inventory account 216 and crediting the COGS account 218. When the adjustment value 230 is positive the corrective transaction 232 is posted by crediting the inventory account 216 and debiting the COGS account 218. Accordingly, for this example, the posting of the corrective transaction 232 at step 234 of the method results in the crediting of the inventory account 216 and the debiting of the COGS account 218 by $5.00, as shown in FIG. 5.

### Predated Inventory Purchase

### Transaction—Situation (c)

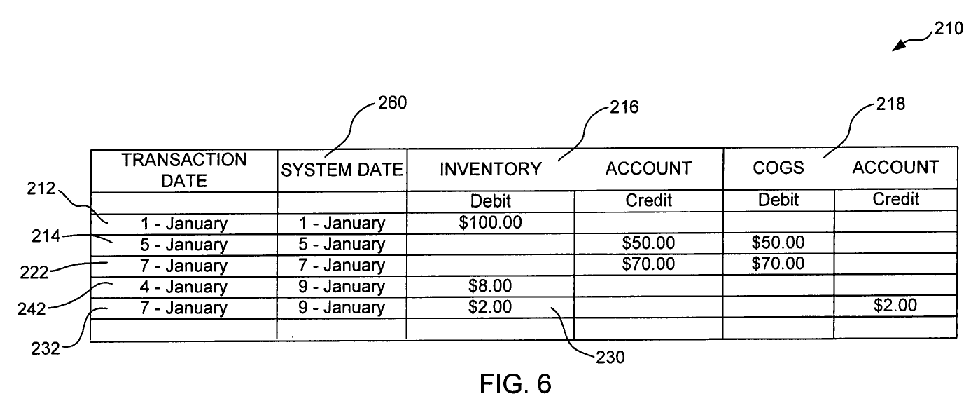

An example of situation (c) will be discussed with reference to the exemplary general ledger 210 of FIG. 6. Initially, the general ledger 210 includes the purchase and sales transactions 212 and 214 dated January 1^{st} and January 5^{th}, respectively, as described above. The general ledger 210 also includes a posting of the inventory sales transaction 222 on January 7^{th} (first transaction date) at a first rate (w) of $10.00 each for a quantity of seven items (first quantity x), of which three items were out of stock (out-of-stock quantity y). Following the posting of the inventory sales transaction 222, an item receipt for a purchase of one item (second quantity p) at a second rate (r) of $8.00 each is discovered having a second transaction date of January 4^{th}, which predates the first transaction date. The discovered inventory purchase transaction is posted to the general ledger 210 on January 9^{th} as inventory purchase transaction 242. As a result, the second quantity p of purchased items is less than the out-of-stock quantity y. In accordance with this embodiment of the invention, the adjustment value is calculated in accordance with Equation 2 resulting in an adjustment value of negative $2.00.

$$\begin{matrix}Adjustment Value = ( p * r ) + ( ( x - p ) * w ) - ( x * w ) \\ = ( 1 * 8 ) + ( ( 7 - 1 ) * 10 ) - ( 7 * 10 ) \\ = - \$2 .00\end{matrix} \qquad Eq . 2$$

As stated above, when the adjustment value 230 is positive, the corrective transaction 232 is posted to the general ledger 210 by crediting the inventory account 216 and debiting the COGS account 218. When the adjustment value 230 is negative, the corrective transaction 232 is posted to the general ledger 210 by debiting the inventory account 216 and crediting the COGS account 218. Accordingly, for this example, the posting of the corrective transaction 232 at step 234 (FIG. 3) of the method, results in the debiting of the inventory account 216 and the crediting of the COGS account 218 by the adjustment value of $2.00.

The posting of a corrective transaction to the general ledger may trigger a need to correct other transaction postings having transaction dates that are subsequent to the corrective transaction. The adjustment values for such additional corrective transactions are calculated in an iterative manner beginning with the earliest affected transaction in accordance with the methods discussed above. In this manner, each transaction that is affected by the corrective transaction posting is adjusted by the posting of additional corrective transactions to the general ledger.

### Nullifying Inventory Transaction Postings

In accordance with another embodiment of the invention, inventory transactions posted to the general ledger are corrected or edited without destroying the sanctity of the general ledger and without having to post the corrective inventory transactions discussed above. This embodiment of present invention generally involves canceling or nullifying inventory transactions that have been posted to the general ledger that are to be edited and reposting a new inventory transaction that includes the desired changes.

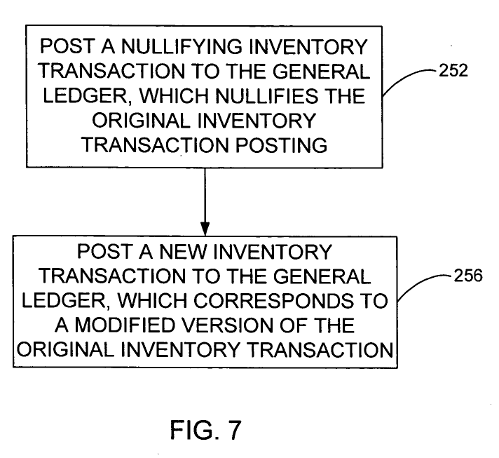

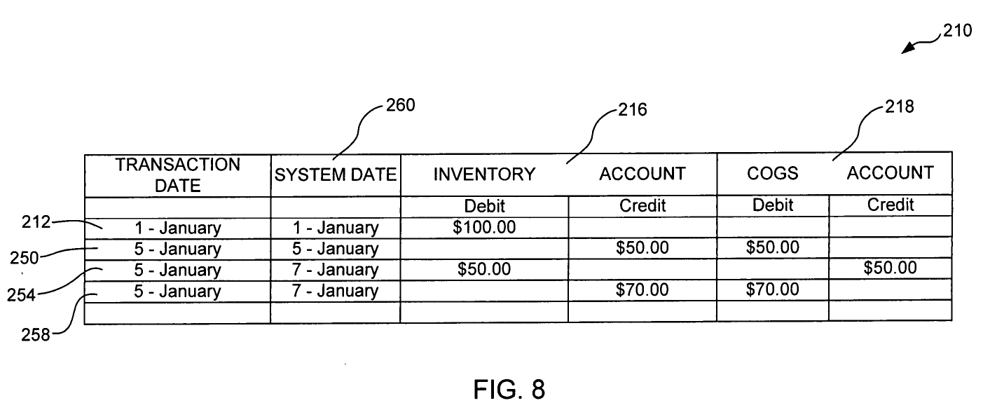

FIG. 7 is a flowchart illustrating the steps of the method and FIG. 8 is a schematic diagram of an exemplary general ledger 210 containing postings in accordance with the method. For this example, the general ledger initially contains the purchase transaction 212 dated January 1^{st}, described above. Additionally, the general ledger includes an original inventory transaction posting, such as an inventory sales transaction 250, for $50.00 (first amount) that consists of a sale of 5 items (first quantity) at a rate of $10.00 (first rate) on January 5^{th} (first transaction date). The first amount is credited to the inventory account and debited from the COGS account.

At step 252 of the method, a nullifying inventory transaction having the first amount is posted to the general ledger for the first transaction date in a manner that operates to nullify the original inventory transaction posting. In the example shown in FIG. 8, a nullifying transaction 254 is posted to the general ledger 210 for the first transaction date of January 5^{th} and for the first amount of $50.00, which is debited from the inventory account 216 and credited to the COGS account 218 to thereby negate the original inventory transaction 250.

Next, at step 256 of the method, a new inventory transaction is posted to the general ledger. The new inventory transaction reflects a desired modification to the original inventory transaction. Accordingly, the new inventory transaction has a second amount that is different from the first amount and generally corresponds to a modified version of the original inventory transaction. In the example shown in FIG. 8, the new transaction 258 is an inventory sales transaction that includes a second amount of $70.00 posted to the general ledger 210 for the first transaction date of January 5^{th}. The postings of the nullifying transaction 254 and the new transaction 258 operate to, in effect, edit the first quantity of the original transaction 250 from five items to seven items. Since none of the transactions posted to the general ledger were deleted or directly edited, this method of the present invention satisfies the preferred rule of auditors and accountants by maintaining the sanctity of the general ledger.

### System Date Information

In accordance with another embodiment of the invention, a system date 260 (FIGS. 4-6 and 8) is entered in the general ledger for posted transactions. The system date 260 is the date on which the transaction is actually posted to the general ledger 210. The system date 260 allows a an auditor or accountant to chronologically follow the postings to the general ledger 210 and thereby assist them in understanding each of the posted transactions including predated transactions and corrective transactions.

Although the present invention has been described with reference to particular embodiments, workers skilled in the art will recognize that changes may be made in form and detail without departing from the spirit and scope of the invention.

1. A method of maintaining a general ledger in a computerized inventory accounting system utilizing a perpetual average inventory valuation comprising steps of:
a) posting an inventory sales transaction having a first transaction date and a first amount that corresponds to a first rate for items in inventory;
b) posting an inventory purchase transaction having a second transaction date, which is before the first transaction date, to the general ledger after the posting step a) that results in a change in the first rate of the inventory sales transaction;
c) calculating an adjustment value corresponding to a change in a the first amount due to the change in the first rate; and
d) posting a corrective transaction to the general ledger having the adjustment value.

2. The method of claim 1, wherein:
the inventory sales transaction includes a sale of a first quantity (x) of the items of an inventory at the first rate (w); and
the inventory purchase transaction includes a purchase of a second quantity (p) of the items at a second rate (r).

3. The method of claim 2, wherein the first quantity (x) is greater than an in-stock quantity of the items when the inventory sales transaction was posted to the general ledger.

4. The method of claim 3, wherein the adjustment value is calculated in the calculating step c) substantially in accordance with the following equation:
Adjustment Value=(y*r)+((x−y)*w)−(x*w)
wherein y represents an out-of-stock quantity of the item as equal to the first quantity (x) minus the in-stock quantity of the item as identified in the general ledger when the inventory sales transaction was posted, and the second quantity (p) is greater than the out-of-stock quantity (y).

5. The method of claim 4, wherein, when the adjustment value is positive, the posting step d) includes:
crediting an inventory account of the general ledger with the adjustment value; and
debiting a Cost Of Goods Sold (COGS) account with the adjustment value.

6. The method of claim 4, wherein, when the adjustment value is negative, the posting step d) includes:
debiting an inventory account of the general ledger with the adjustment value; and
crediting a Cost Of Goods Sold (COGS) account with the adjustment value.

7. The method of claim 3, wherein the adjustment value is calculated in the calculating step c) substantially in accordance with the following equation:
adjustment value=(p*r)+((x−p)*w)−(x*w);
wherein y represents an out-of-stock quantity that is equal to the first quantity minus the in-stock quantity of the item as identified in the general ledger when the inventory sales transaction was posted, and the second quantity (p) is less than the out-of-stock quantity (y).

8. The method of claim 7, wherein, when the adjustment value is positive, the posting step d) includes:
crediting an inventory account of the general ledger with the adjustment value; and
debiting a Cost Of Goods Sold (COGS) account with the adjustment value.

9. The method of claim 7, wherein, when the adjustment value is negative, the posting step d) includes:
debiting an inventory account of the general ledger with the adjustment value; and
crediting a Cost Of Goods Sold (COGS) account with the adjustment value.

10. The method of claim 1 including posting a system date to the general ledger corresponding to the date of the posting of the inventory purchase transaction to the general ledger.

11. A computer-readable medium having stored thereon executable instructions to perform the steps of the method of claim 1.

12. A method of maintaining a general ledger in a computerized inventory accounting system utilizing a perpetual average inventory valuation comprising steps of:
a) posting an inventory sales transaction to the general ledger that includes a sale of a first quantity (x) of items (sold items) of an inventory at a first rate (w) on a first transaction date;
b) posting an inventory purchase transaction to the general ledger after the posting step a) that includes a purchase of a second quantity (p) of the items at a second rate (r) on a second transaction date, which is before the first transaction date;
c) calculating an adjustment value corresponding to a change in a value of the posted inventory sales transaction due to a valuation change for the sold items as a result of the posted inventory purchase transaction; and
d) posting a corrective transaction to the general ledger having the adjustment value.

13. The method of claim 12, wherein the first quantity (x) is greater than an in-stock quantity of the items when the inventory sales transaction was posted to the general ledger.

14. The method of claim 13, wherein the adjustment value is calculated in the calculating step c) substantially in accordance with the following equation:
adjustment value=(y*r)+(x−y)*w−(x*w)
wherein y represents an out-of-stock quantity of the item as equal to the first quantity (x) minus the in-stock quantity of the item as identified in the general ledger when the inventory sales transaction was posted, and the second quantity (p) is greater than the out-of-stock quantity (y).

15. The method of claim 14, wherein, when the adjustment value is positive, the posting step d) includes:
crediting an inventory account of the general ledger with the adjustment value; and
debiting a Cost Of Goods Sold (COGS) account with the adjustment value.

16. The method of claim 14, wherein, when the adjustment value is negative, the posting step d) includes:
debiting an inventory account of the general ledger with the adjustment value; and
crediting a Cost Of Goods Sold (COGS) account with the adjustment value.

17. The method of claim 13, wherein the adjustment value is calculated in the calculating step c) substantially in accordance with the following equation:
adjustment value=(p*r)+(x−p)*w−(x*w);
wherein y represents an out-of-stock quantity that is equal to the first quantity minus the in-stock quantity of the item as identified in the general ledger when the inventory sales transaction was posted, and the second quantity (p) is less than the out-of-stock quantity (y).

18. The method of claim 17, wherein, when the adjustment value is positive, the posting step d) includes:
crediting an inventory account of the general ledger with the adjustment value; and
debiting a Cost Of Goods Sold (COGS) account with the adjustment value.

19. The method of claim 17, wherein, when the adjustment value is negative, the posting step d) includes:
debiting an inventory account of the general ledger with the adjustment value; and
crediting a Cost Of Goods Sold (COGS) account with the adjustment value.

20. The method of claim 12 including posting a system date to the general ledger corresponding to the date of the posting of the inventory purchase transaction to the general ledger.

21. A computer-readable medium having stored thereon executable instructions to perform the steps of the method of claim 12.

22. In a computerized inventory accounting system having a general ledger containing an original inventory transaction posting of a first amount corresponding to a sale or purchase of a first quantity of items at a first rate, a method of editing the original transaction posting comprising steps of:
a) posting a nullifying inventory transaction having the original amount to the general ledger such that it nullifies the original inventory transaction posting; and
b) posting a new inventory transaction to the general ledger having a second amount that is different from the first amount, whereby the new inventory transaction posting corresponds to a modified version of the original inventory transaction.

23. The method of claim 22, wherein the general ledger includes an inventory account and a Cost Of Goods Sold (COGS) account.

24. The method of claim 23, wherein:
the original transaction posting is a sale of items and the original transaction posting includes a credit of the first amount to the inventory account and a debit of the first amount to the COGS account; and
the nullifying inventory transaction posting includes a debit of the first amount to the inventory account and a credit of the first amount to the COGS account.

25. The method of claim 23, wherein:
the original transaction posting is a purchase of items and the original inventory transaction posting includes a debit of the first amount to the inventory account and a credit of the first amount to the COGS account; and
the nullifying inventory transaction posting includes a credit of the first amount to the inventory account and a debit of the first amount to the COGS account.
